(19) United States
(12) Patent Application Publication
(10) Pub. No.: US 2016/0273917 A1
(43) Pub. Date: Sep. 22, 2016

(54) ANGULAR VELOCITY SENSOR ELEMENT AND ANGULAR VELOCITY SENSOR

(71) Applicant: PANASONIC INTELLECTUAL PROPERTY MANAGEMENT CO., LTD., Osaka-shi, Osaka (JP)

(72) Inventor: Yasunobu KOBAYASHI, Fukui (JP)

(21) Appl. No.: 15/037,032

(22) PCT Filed: Nov. 11, 2014
(86) PCT No.: PCT/JP2014/005656

§ 371 Date: May 16, 2016

(30) Foreign Application Priority Data
Nov. 22, 2013 (JP) 2013-241596

(51) Int. Cl. G01C 19/5705

(52) U.S. Cl. CPC G01C 19/5705

(57) ABSTRACT

An angular velocity sensor element includes a fixed section, an extending section having an end coupled to the fixed section and extending in a direction of a first axis, a first drive vibrator coupled to the extending section and extending in a direction of a second axis perpendicular to the first axis, a first detection vibrator coupled to the first drive vibrator and extending in the direction of the first axis, and a second detection vibrator coupled to first detection vibrator and extending in the direction of the second axis. In the angular velocity sensor element, the first drive vibrator is driven to perform a flexural vibration in a direction of a third axis perpendicular to the first and second axes, and the first detection vibrator detects an angular velocity around the first axis, and the second detection vibrator detects an angular velocity around the second axis.

### BACKGROUND

1. Technical Field

The present disclosure relates to an angular velocity sensor element and an angular velocity sensor.

2. Background Art

FIG. 10 is a perspective view of a conventional angular velocity sensor element.

The angular velocity sensor includes fixed section 1, four extending sections 2, and four vibrators 3. Fixed section 1 forms a square frame of which inside is hollow. Each of extending sections 2 extends from each of four corners of frame-like fixed section 1 to an approx. center of fixed section 1. Each of extending sections 2 intersects each other at the center of fixed section 1. Each of four vibrators 3 is disposed such that it passes from the intersection of extending sections 2 toward the outside. Each of vibrators 3 is provided with a piezoelectric film.

Actions of the foregoing conventional angular velocity sensor element are described hereinafter.

An application of a drive signal from a driver circuit to the angular velocity sensor element twists, vibrates and drives four vibrators 3 as FIG. 10 shows. At this time, an application of an angular velocity around X-axis or Y-axis orthogonal to Z-axis causes Coriolis force to work perpendicularly to the drive vibrating direction within a plane orthogonal to the respective one of axes. For instance, an application of angular velocity around X-axis causes the Coriolis force to work along Y-axis as FIG. 11 shows. An application of an angular velocity around Y-axis causes the Coriolis force to work along X-axis as FIG. 12 shows. Vibrators 3 receive the Coriolis force, thereby generating electric charges due to piezoelectric effect. A detecting circuit detects the electric charges as an electric signal, so that an angular velocity signal can be calculated.

Unexamined Japanese Patent Application Publication No. 2009-74996 is known as a related art literature disclosing a technique similar to the conventional technique discussed above.

### SUMMARY

The angular velocity sensor element of the present disclosure includes a fixed section, an extending section, a first drive vibrator, a first detection vibrator and a second detection vibrator. The extending section has a first end coupled to the fixed section, and extends in a direction of a first axis. The first drive vibrator is coupled to the extending section, and extends in a direction of a second axis perpendicular to the first axis. The first detection vibrator is coupled to the first drive vibrator and extends in the direction of the first axis. The second detection vibrator is coupled to the first drive vibrator and extends in the direction of the second axis. The first drive vibrator is driven to perform a flexural vibration in a direction of a third axis perpendicular to the first and second axes, thereby allowing the first detection vibrator to detect an angular velocity around the first axis, and the second detection vibrator to detect an angular velocity around the second axis.

The angular velocity sensor of the present disclosure includes the angular velocity sensor element described above, a drive circuit, and a process circuit. The drive circuit outputs a drive signal that drives the angular velocity sensor element. The process circuit processes a signal output from the angular velocity sensor element.

The angular velocity sensor element and the angular velocity sensor of the present disclosure achieve simple adjustment in drive.

### BRIEF DESCRIPTION OF DRAWINGS

FIG. 1 is a block diagram of an angular velocity sensor in accordance with an embodiment of the present disclosure.

FIG. 2 is a perspective exploded view of the angular velocity sensor in accordance with the embodiment.

FIG. 3 is a top view of the angular velocity sensor in accordance with the embodiment.

FIG. 4 is a sectional view of the angular velocity sensor element shown in FIG. 3 cut along line IV-IV.

FIG. 5 is a sectional view of the angular velocity sensor element shown in FIG. 3 cut along line V-V

FIGS. 6A to 6E show manufacturing steps of the angular velocity sensor element in accordance with an embodiment of the present disclosure.

FIGS. 7 to 9 show actions of the angular velocity sensor element in accordance with an embodiment of the present disclosure.

FIG. 10 is a perspective view illustrating that a conventional angular velocity sensor element is driven to perform a flexural vibration in a twisting direction.

FIG. 11 is a perspective view illustrating that the conventional angular velocity sensor element detects an angular velocity around X-axis.

FIG. 12 is a perspective view illustrating that the conventional angular velocity sensor element detects an angular velocity around Y-axis.

### DETAILED DESCRIPTION OF PREFERRED EMBODIMENT

An exemplary embodiment of the present disclosure is demonstrated hereinafter with reference to the accompanying drawings. The embodiment is an example of the present disclosure, which is thus not limited to this embodiment.

### 1. Exemplary Embodiment

1-1. Structure of Angular Velocity Sensor

The angular velocity sensor in accordance with the embodiment is used in a variety of electronic devices such as vehicle controllers, car navigation systems, digital still cameras, and portable information terminals.

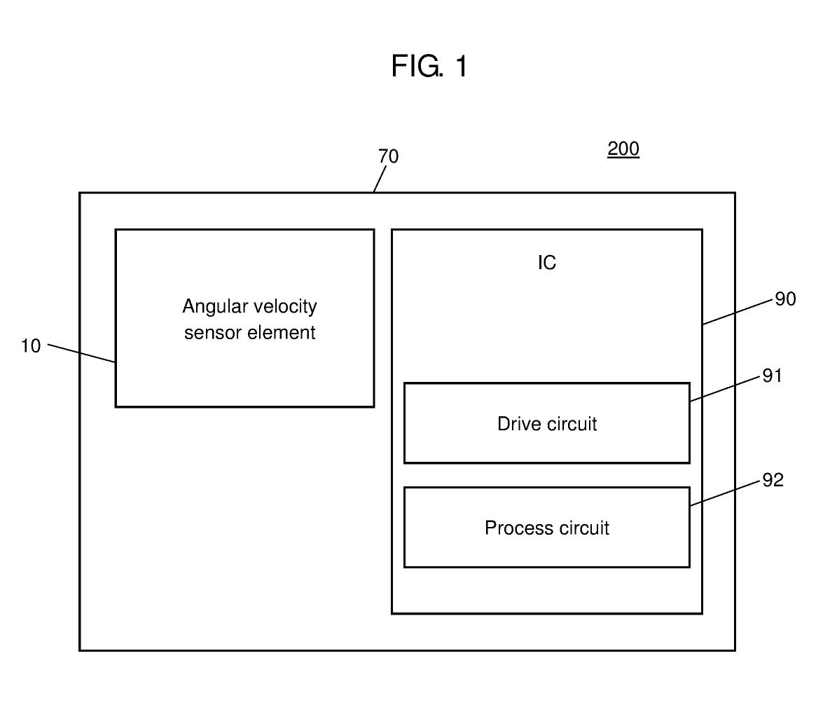

FIG. 1 is a simple block diagram of angular velocity sensor 200 in accordance with the embodiment. As FIG. 1 shows, angular velocity sensor 200 includes angular velocity sensor element 10, drive circuit 91, and process circuit 92. Drive circuit 91 outputs a drive signal for driving the sensor element 10. Process circuit 92 processes the signal output from sensor element 10. Drive circuit 91 and process circuit 92 can be integrated into integrated circuit (IC) 90. Angular velocity sensor element 10, drive circuit 91, and process circuit 92 can be accommodated in housing 70.

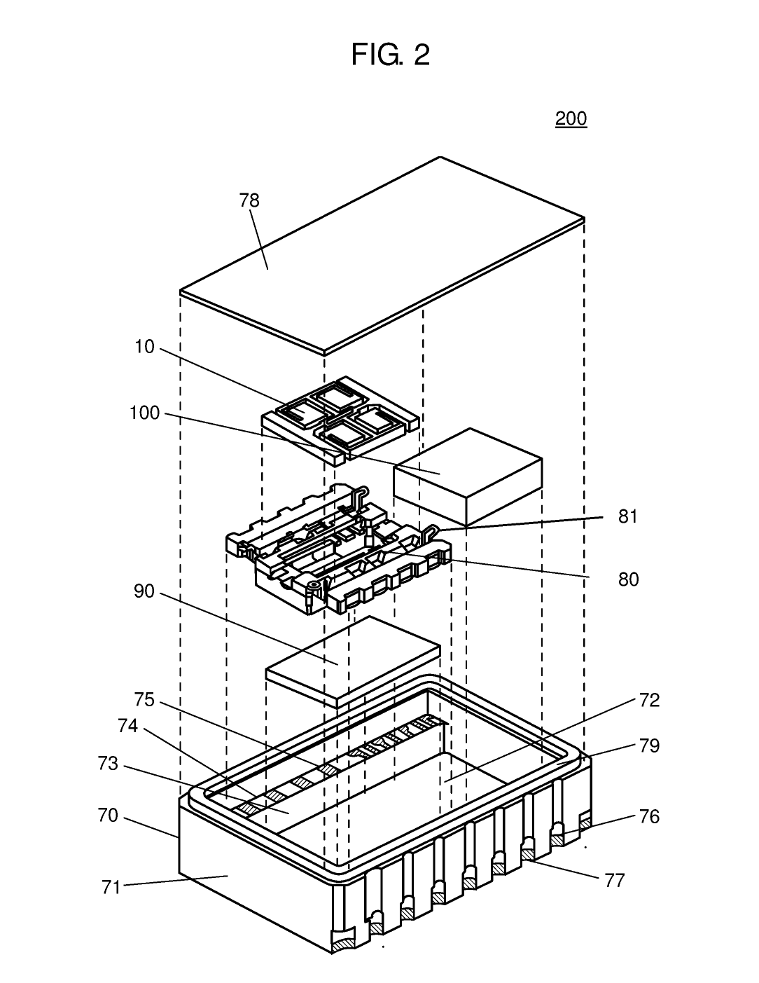

FIG. 2 is a perspective exploded view illustrating a detailed structure of angular velocity sensor 200, which includes placement member 80 and acceleration sensor element 100 in addition to angular velocity sensor element 10, IC 90, and housing 70.

Each of the foregoing structural members are demonstrated hereinafter.

Housing 70 includes container section 71 and upper lid 78. Container section 71 has a hollow space inside, and a face thereof forms an opening. Upper lid 78 can hermetically close the opening of container section 71. Container section 71 includes an inner bottom face, an inner lateral face, and an outer underside which are formed of laminar structure made of ceramic and conductor for wiring. The inner bottom face of container section 71 is formed of multi-layered circuit board 72 that includes wiring patterns. An inner face of lateral wall 73 of container section 71 includes step section 74, on which terminal electrodes 75 are formed. Power supply electrode 76, ground electrode 77 (hereinafter referred to as GND electrode 77), and an output electrode are formed on the outer underside of container section 71. Power supply electrode 76, GND electrode 77, and the output electrode are electrically connected to terminal electrodes 75 via wiring patterns respectively. Power supply electrode 76, GND electrode 77, and the output electrode are not necessarily provided on the outer underside of housing 70, and they can be provided to other outer faces of housing 71 or to an outer face of upper lid 78. Metal frame 79 is provided on a top face of lateral wall 73 of container section 71, which is made of ceramic. Metal frame 79 is made of kovar. Terminal electrode 75 is made of gold. Power supply electrode 76, GND electrode 77, and the output electrode are made of silver. Upper lid 78 is made of kovar. These materials are only examples, and they can be changed appropriately. Housing 70 does not need upper lid 78 if hermetic seal is not required.

Placement member 80 accommodates angular velocity sensor element 10, and supports angular velocity sensor element 10 at first fixed section 21 and second fixed section 28 which are detailed later. Placement member 80 includes eight terminals 81, which support placement member 80 at the circumference. Eight terminals 81 are electrically connected to electrode pads of angular velocity sensor element 10 via wires, and also electrically connected to terminal electrodes 75 of housing 70, respectively. Placement member 80 is made of resin, and the wires are made of conductive material such as aluminum.

Acceleration sensor element 100 is disposed on the inner bottom face of container section 71 of housing 70, and is electrically connected to terminal electrodes 75 of housing 70 via wires which are made of conductive material such as aluminum.

IC 90 is disposed next to acceleration sensor element 100 on the inner bottom face of container section 71 of housing 70. Process circuit 92 integrated in IC 90 processes not only the signal output from angular velocity sensor element 10 but also a signal output from acceleration sensor element 100.

1-2. Structure of the Angular Velocity Sensor Element

The structure of angular velocity sensor element 10 in accordance with the embodiment is demonstrated hereinafter.

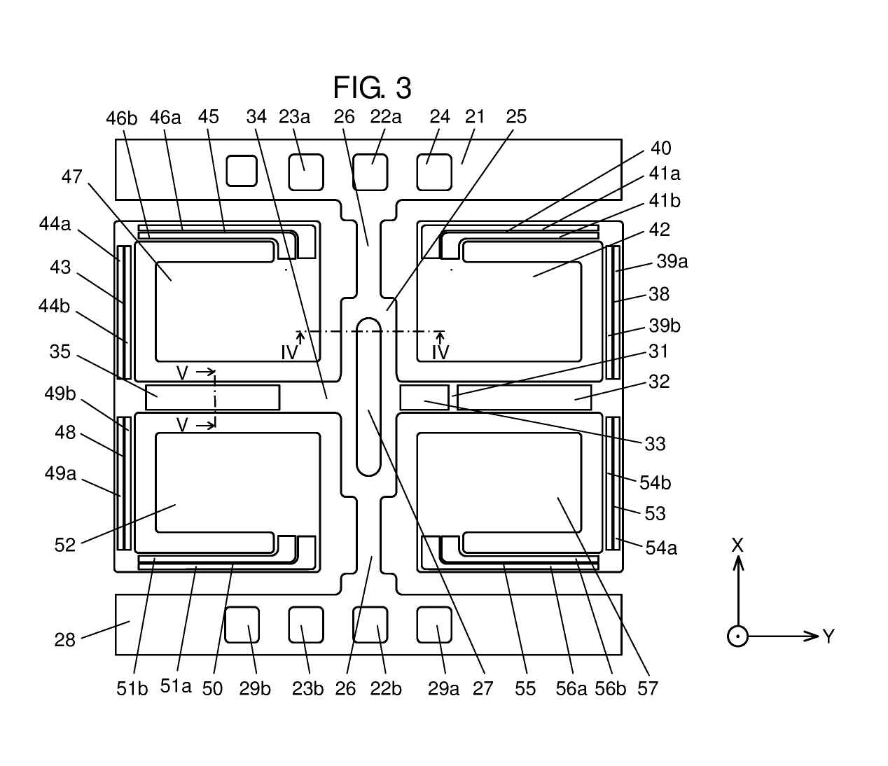

FIG. 3 is a top view of angular velocity sensor element 10. On the paper of FIG. 3, assume that an up-down direction is X-axis direction, a left-right direction is Y-axis direction, a vertical direction with respect to the paper is Z-axis direction which is a thickness direction of angular velocity sensor element 10. X-axis, Y-axis, and Z-axis are perpendicular to each other. Angular velocity sensor element 10 detects angular velocities around X-axis and Y-axis.

Angular velocity sensor element 10 has first fixed section 21, second fixed section 28, extending section 25, first drive vibrator 31, second drive vibrator 34, first detection vibrator 38, second detection vibrator 40, third detection vibrator 43, fourth detection vibrator 45, fifth detection vibrator 53, sixth detection vibrator 55, seventh detection vibrator 48, and eighth detection vibrator 50.

Angular velocity sensor element 10 further includes first weight 42, second weight 47, third weight 57, and fourth weight 52.

First fixed section 21 is disposed at an end in X-axis direction of sensor element 10, and fixes the end of extending section 25 in X-axis direction. On a surface of first fixed section 21, there are first detection electrode pad 22a, second detection electrode pad 23a, and monitor electrode pad 24.

Second fixed section 28 is located at an end in X-axis direction of sensor element 10, and this end is opposite to the end at which first fixed section 21 is disposed. Second fixed section 28 fixes the end of extending section 25 in X-axis direction, and this end is opposite to the end which is fixed by first fixed section 21. On a surface of second fixed section 28, there are first drive electrode pad 29a, second drive electrode pad 29b, third detection electrode pad 22b, and fourth detection electrode pad 23b.

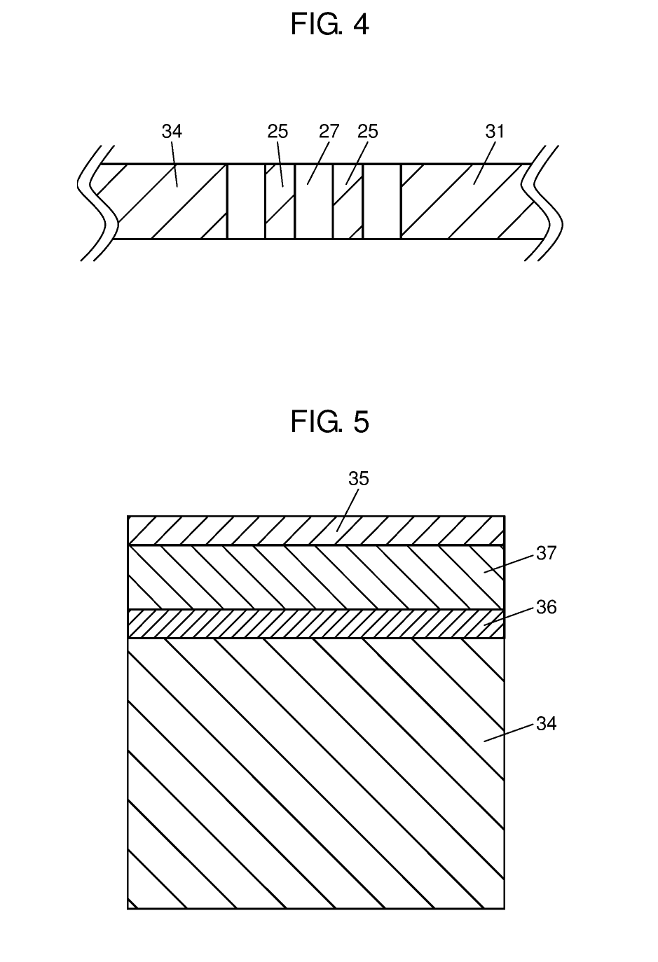

Extending section 25 is shaped like a plate of which the longitudinal direction goes along X-axis, and extends in X-axis direction. Extending section 25 includes a pair of narrow sections 26, each of which is located closer to first fixed section 21 and closer to second fixed section 28 than a center part thereof. Narrow sections 26 are narrower in Y-axis direction than end parts connected to first fixed section 21 and second fixed section 28, respectively. FIG. 4 is a sectional view of angular velocity sensor element 10 shown in FIG. 3 cut along line IV-IV, and shows the center part of extending section 25. As FIG. 4 shows, extending section 25 is provided with hole 27 penetrating through the center part in Z-axis direction.

First drive vibrator 31 is shaped like a plate of which the longitudinal direction goes along Y-axis, and of which a first end in Y-axis direction is connected to the center part of extending section 25. First drive vibrator 31 extends in Y-axis direction, and on a surface of first drive vibrator 31, there are first drive electrode 32 and monitor electrode 33. Widths of electrodes 32 and 33 in Y-axis direction are greater than the widths thereof in X-axis direction and Z-axis direction.

Second drive vibrator 34 is shaped like a plate of which the longitudinal direction goes along Y-axis, and of which a first end in Y-axis direction is connected to the center part of extending section 25. Second drive vibrator 34 extends in Y-axis direction but opposite to first drive vibrator 31. Second drive vibrator 34 and first drive vibrator 31 are placed symmetrically with respect to extending section 25. In other words, second drive vibrator 34 and first drive vibrator 31 are in line symmetry with respect to a straight line passing through the center of angular velocity sensor element 10 and in parallel with X-axis. On a surface of second drive vibrator 34, there is second drive electrode 35 of which width in Y-axis direction is greater than the widths thereof in X-axis and Z-axis. Second drive vibrator 34 is made of silicon.

First detection vibrator 38 is shaped like a plate of which the longitudinal direction goes along X-axis direction, and of which a first end in X-axis direction is connected to a second end opposite to the first end connected to extending section 25, of first drive vibrator 31 along Y-axis. First detection vibrator 38 extends along X-axis from first drive vibrator 31 toward first fixed section 21. On a surface of vibrator 38, there is a pair of first detection electrodes 39a and 39b disposed in Y-axis direction. First detection electrode 39a is disposed outside, and first detection electrode 39b is disposed inner side of first detection electrode 39a.

Second detection vibrator 40 is shaped like a plate of which the longitudinal direction goes along Y-axis direction, and of which a first end in Y-axis direction is connected to a second end, opposite to the first end connected to first drive vibrator 31, of first detection vibrator 38 along X-axis. Second detection vibrator 40 extends along Y-axis from first detection vibrator 38 toward extending section 25. On a surface of vibrator 40, there is a pair of second detection electrodes 41a and 41b disposed in X-axis direction. Second detection electrode 41a is disposed outside, and second detection electrode 41b is disposed inner side of second detection electrode 41a.

Third detection vibrator 43 is shaped like a plate of which the longitudinal direction goes along X-axis direction, and of which a first end in X-axis direction is connected to a second end, opposite to the first end connected to extending section 25, of second drive vibrator 34 along Y-axis. Third detection vibrator 43 extends along X-axis from second drive vibrator 34 toward first fixed section 21. Third detection vibrator 43 and first detection vibrator 38 are placed symmetrically with respect to extending section 25. In other words, third detection vibrator 43 and first detection vibrator 38 are in line symmetry with respect to the straight line passing through the center of angular velocity sensor element 10 and in parallel with X-axis. On a surface of third detection vibrator 43, there is a pair of third detection electrodes 44a and 44b disposed in Y-axis direction. Third detection electrode 44a is disposed outside, and third detection electrode 44b is disposed inner side of third detection electrode 44a.

Fourth detection vibrator 45 is shaped like a plate of which the longitudinal direction goes along Y-axis direction, and of which a first end in Y-axis direction is connected to a second end, opposite to the first end connected to second drive vibrator 34, of third detection vibrator 43 along X-axis. Fourth detection vibrator 45 extends along Y-axis from third detection vibrator 43 toward extending section 25. Fourth detection vibrator 45 and second detection vibrator 40 are placed symmetrically with respect to extending section 25. In other words, fourth detection vibrator 45 and second detection vibrator 40 are in line symmetry with respect to the straight line passing through the center of angular velocity sensor element 10 and in parallel with X-axis. On a surface of vibrator 45, there is a pair of fourth detection electrodes 46a and 46b disposed in X-axis direction. Fourth detection electrode 46a is disposed outside, and fourth detection electrode 46b is disposed inner side of fourth detection electrode 46a.

Fifth detection vibrator 53 is shaped like a plate of which the longitudinal direction goes along X-axis direction, and of which a first end in X-axis direction is connected to a second end, opposite to the first end connected to extending section 25, of first drive vibrator 31 along Y-axis. Fifth detection vibrator 53 extends along X-axis from first drive vibrator 31 in a direction opposite to first detection vibrator 38. Fifth detection vibrator 53 and first detection vibrator 38 are placed symmetrically with respect to first drive vibrator 31. In other words, fifth detection vibrator 53 and first detection vibrator 38 are in line symmetry with respect to a straight line passing through the center of angular velocity sensor element 10 and in parallel with Y-axis. On a surface of vibrator 53, there is a pair of fifth detection electrodes 54a and 54b disposed in Y-axis direction. Fifth detection electrode 54a is disposed outside, and fifth detection electrode 54b is disposed inner side of fifth detection electrode 54a.

Sixth detection vibrator 55 is shaped like a plate of which the longitudinal direction goes along Y-axis direction, and of which a first end in Y-axis direction is connected to a second end, opposite to the first end connected to first drive vibrator 31, of fifth detection vibrator 53 along X-axis. Sixth detection vibrator 55 extends along Y-axis from fifth detection vibrator 53 toward extending section 25. Sixth detection vibrator 55 and second detection vibrator 40 are placed symmetrically with respect to first drive vibrator 31. In other words, sixth detection vibrator 55 and second detection vibrator 40 are in line symmetry with respect to the straight line passing through the center of angular velocity sensor element 10 and in parallel with Y-axis. On a surface of vibrator 55, there is a pair of sixth detection electrodes 56a and 56b disposed in X-axis direction. Sixth detection electrode 56a is disposed outside, and sixth detection electrode 56b is disposed inner side of sixth detection electrode 56a.

Seventh detection vibrator 48 is shaped like a plate of which the longitudinal direction goes along X-axis direction, and of which a first end in X-axis direction is connected to a second end, opposite to the first end connected to extending section 25, of second drive vibrator 34 along Y-axis. Seventh detection vibrator 48 extends along X-axis from second drive vibrator 34 in a direction opposite to third detection vibrator 43. Seventh detection vibrator 48 and third detection vibrator 43 are placed symmetrically with respect to second drive vibrator 34. In other words, seventh detection vibrator 48 and third detection vibrator 43 are in line symmetry with respect to the straight line passing through the center of angular velocity sensor element 10 and in parallel with Y-axis. Seventh detection vibrator 48 and fifth detection vibrator 53 are placed symmetrically with respect to extending section 25. In other words, seventh detection vibrator 48 and third detection vibrator 43 are in line symmetry with respect to the straight line passing through the center of angular velocity sensor element 10 and in parallel with X-axis. On a surface of vibrator 48, there is a pair of seventh detection electrodes 49a and 49b disposed in Y-axis direction. Seventh detection electrode 49a is disposed outside, and seventh detection electrode 49b is disposed inner side of seventh detection electrode 49a.

Eighth detection vibrator 50 is shape like a plate of which the longitudinal direction goes along Y-axis direction, and of which a first end in Y-axis direction is connected to a second end, opposite to the first end connected to second drive vibrator 34, of seventh detection vibrator 48 along X-axis. Eighth detection vibrator 50 extends along Y-axis from seventh detection vibrator 48 toward extending section 25. Eighth detection vibrator 50 and fourth detection vibrator 45 are placed symmetrically with respect to second drive vibrator 34. In other words, eighth detection vibrator 50 and fourth detection vibrator 45 are in line symmetry with respect to the straight line passing through the center of angular velocity sensor element 10 and in parallel with Y-axis. Eighth detection vibrator 50 and sixth detection vibrator 55 are placed symmetrically with respect to extending section 25. In other words, eighth detection vibrator 50 and sixth detection vibrator 55 are in line symmetry with respect to the straight line passing through the center of angular velocity sensor element 10 and in parallel with X-axis. On a surface of vibrator 50, there is a pair of eighth detection electrodes 51a and 51b disposed in X-axis direction. Eighth detection electrode 51a is disposed outside, and eighth detection electrode 51b is disposed inner side of eighth detection electrode 51a.

Each of first weight 42, second weight 47, third weight 57, and fourth weight 52 is shaped like a rectangle.

A corner of first weight 42 is connected to second detection vibrator 40 at a second end opposite to the first end connected to first detection vibrator 38. First weight 42 is disposed in a space of which three sides out of four sides are surrounded by first drive vibrator 31, first detection vibrator 38, and second detection vibrator 40.

A corner of second weight 47 is connected to fourth detection vibrator 45 at a second end opposite to the first end connected to third detection vibrator 43. Second weight 47 is disposed in a space of which three sides out of four sides are surrounded by second drive vibrator 34, third detection vibrator 43, and fourth detection vibrator 45.

A corner of third weight 57 is connected to sixth detection vibrator 55 at a second end opposite to the first end connected to fifth detection vibrator 53. Third weight 57 is disposed in a space of which three sides out of four sides are surrounded by first drive vibrator 31, fifth detection vibrator 53, and sixth detection vibrator 55.

A corner of fourth weight 52 is connected to eighth detection vibrator 50 at a second end opposite to the first end connected to seventh detection vibrator 48. Fourth weight 52 is disposed in a space of which three sides out of four sides are surrounded by second drive vibrator 34, seventh detection vibrator 48, and eighth detection vibrator 50.

First fixed sections 21, second fixed section 28, extending section 25, first drive vibrators 31, second drive vibrator 34, first to eighth detection vibrators 34, 40, 43, 45, 53, 55, 48, and 50, and first to fourth weights 42, 47, 57, and 52 are made of silicon.

Structures of the electrodes of angular velocity sensor element 10 are described hereinafter.

FIG. 5 is a sectional view of second drive vibrator 34 shown in FIG. 3 cut along line V-V. As FIG. 5 shows, common ground electrode 36 and piezoelectric layer 37 are disposed between second drive electrode 35 and second drive vibrator 34. Common ground electrode 36 is disposed on second drive vibrator 34 and is made of alloy of platinum and titanium. Piezoelectric layer 37 is disposed on common ground electrode 36 and is made of lead -zirconate -titanate.

Similar to second drive electrode 35, common ground electrode 36 and piezoelectric layer 37 are disposed under first drive electrode 32, monitor electrode 33, first detection electrodes 39a and 39b, second detection electrodes 41a and 41b, third detection electrodes 44a and 44b, fourth detection electrodes 46a and 46b, fifth detection electrodes 54a and 54b, sixth detection electrodes 56a and 56b, seventh detection electrodes 49a and 49b, and eighth detection electrodes 51a and 51b.

Electric connections between each one of electrode pads disposed to first fixed section 21 and each one of the electrodes are described hereinafter. The electrode pads refer to first detection electrode pad 22a, second detection electrode pad 23a, and monitor electrode pad 24.

First detection electrode pad 22a is electrically connected to first detection electrode 39a and fifth detection electrode 54a via a wiring pattern passing through first drive vibrator 31. First detection electrode pad 22a is electrically connected to third detection electrode 44a and seventh detection electrode 49a via a wiring pattern passing through second drive vibrator 34.

Second detection electrode pad 23a is electrically connected to second detection electrode 41a and sixth detection electrode 56b via a wiring pattern passing through first drive vibrator 31. Second detection electrode pad 23a is electrically connected to fourth detection electrode 46b and eight detection electrode 51a via a wiring pattern passing through second drive vibrator 34.

Monitor electrode pad 24 is electrically connected to monitor electrode 33 via a wiring pattern.

Next, electric connections between each one of electrode pads disposed to second fixed section 28 and each one of the electrodes are described hereinafter. The electrode pads refer to first drive electrode pad 29a, second drive electrode pad 29b, third detection electrode pad 22b, and fourth detection electrode pad 23b.

First drive electrode pad 29a is electrically connected to first drive electrode 32 via a wiring pattern.

Second drive electrode pad 29b is electrically connected to second drive electrode 35 via a wiring pattern.

Third detection electrode pad 22b is electrically connected to first detection electrode 39b and fifth detection electrode 54b via a wiring pattern passing through first drive vibrator 31. Third detection electrode pad 22b is also electrically connected to third detection electrode 44b and seventh detection electrode 49b via a wiring pattern passing through second drive vibrator 34.

Fourth detection electrode pad 23b is electrically connected to second detection electrode 41b and sixth detection electrode 56a via a wiring pattern passing through first drive vibrator 31. Fourth detection electrode pad 23b is also electrically connected to fourth detection electrode 46a and eighth detection electrode 51b via a wiring pattern passing through second drive vibrator 34.

1-3. Method for manufacturing angular velocity sensor element and angular velocity sensor

Methods for manufacturing the angular velocity sensor element and the angular velocity sensor are demonstrated hereinafter.

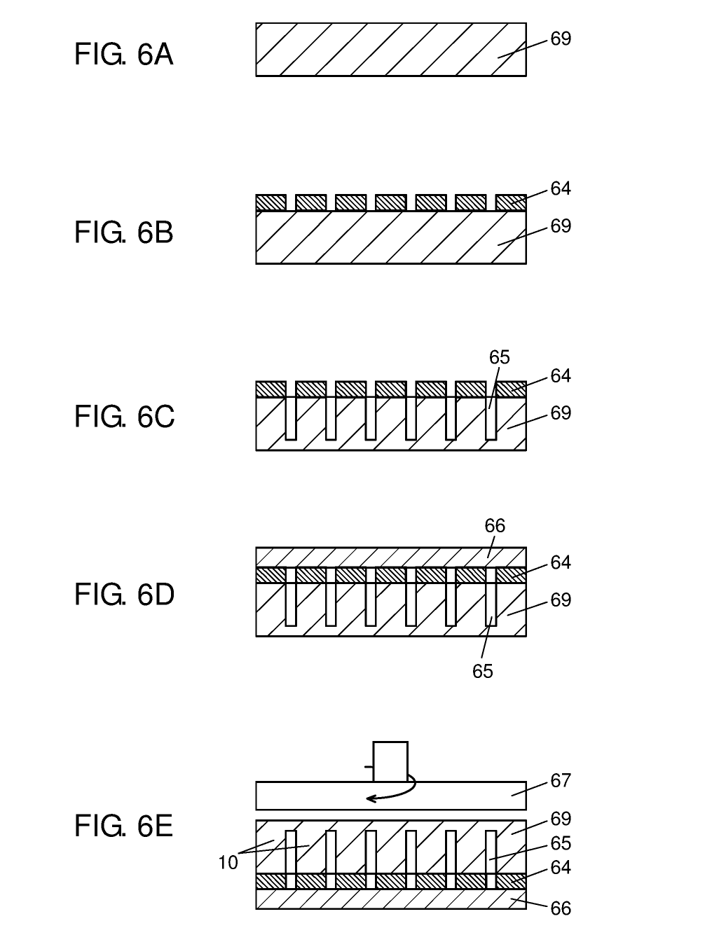

First, a method for manufacturing angular velocity sensor element 10 is demonstrated hereinafter. FIG. 6A to FIG. 6F show manufacturing steps of angular velocity sensor element 10.

As FIG. 6A shows, wafer 69 made of silicon is prepared. On a surface of wafer 69, the following structural elements have been formed in advance: common ground electrode 36, piezoelectric layer 37, first drive electrode pad 29a, second drive electrode pad 29b, first detection electrode pad 22a, second detection electrode pad 23a, third detection electrode pad 22b, fourth detection electrode pad 23b, monitor electrode pad 24, first drive electrode 32, second drive electrode 35, first detection electrodes 39a and 39b, second detection electrodes 41a and 41b, third detection electrodes 44a and 44b, fourth detection electrodes 46a and 46b, fifth detection electrodes 54a and 54b, sixth detection electrodes 56a and 56b, seventh detection electrodes 49a and 49b, eighth detection electrodes 51a and 51b, monitor electrode 33, and wiring patterns.

Then, resist film 64 is formed on the surface of wafer 69 by a spin coating method. Resist film 64 is made of, for instance, aluminum, titanium, silicon oxide, or silicon nitride. Thereafter, as shown in FIG. 6B, resist film 64 is patterned in a predetermined pattern by a photolithography method.

Next, wafer 69 is placed in a dry-etching apparatus, and fluorine-based gas such as sulfur hexafluoride (SF₆) and carbon tetrafluoride (CF₄) is introduced. Then as shown in FIG. 6C, wafer 69 is etched except a region coated with resist film 64, whereby grooves 65 are formed.

Next as FIG. 6D shows, film 66 having an adhesive layer is put on a surface of resist film 64. A thickness of film 66 ranges from 50 to 200 μm. Film 66 functions protecting the surface of wafer 69 in a back-grinding step detailed later and shown in FIG. 6E.

Then as FIG. 6E shows, wafer 69 is turned upside-down, and film 66 provided to wafer 69 is fixed to a chuck table, and then back-grinding wheel 67 is rotated to grind a backside of wafer 69.

Finally, film 66 is irradiated with UV for reducing its adhesive strength, so that film 66 is peeled off from the surface of resist film 64, which is then removed for taking out pieces of angular velocity sensor elements 10 from wafer 69.

Angular velocity sensor element 10 can be thus produced through the steps discussed above.

A method for manufacturing angular velocity sensor 200 shown in FIG. 2 is demonstrated hereinafter.

First, multilayer circuit board 72 is prepared.

Then lateral wall 73 and step section 74 are formed on an outer periphery of a top face of multilayer circuit board 72. On a top face of step section 74, terminal electrodes 75 are formed. To a top face of lateral wall 73, metal frame 79 is rigidly mounted.

On an underside of multilayer circuit board 72, power-supply electrode 76, GND electrode 77, and the output electrode are formed.

Next, on the top face of multilayer circuit board 72, IC 90 is mounted and electrically connected to multilayer circuit board 72.

On the top face of multilayer circuit board 72, acceleration sensor element 100 is mounted next to IC 90. Acceleration sensor element 100 is electrically connected to terminal electrodes 75 of housing 70 via wires by a wire-bonding method.

On the other hand, eight terminals 81 are formed by an insert-molding method on placement member 80. First fixed section 21 and second fixed section 28 of angular velocity sensor element 10 are rigidly mounted to placement member 80 at their undersides. Then, terminals 81 of placement member 80 are electrically connected with the following pads respectively via wires by the wire-bonding method: first and second drive electrode pads 29a and 29b of first and second fixed sections 21 and 28, first detection electrode pad 22a, second detection electrode pad 23a, third detection electrode pad 22b, fourth detection electrode pad 23b, and monitor electrode pad 24.

Next, eight terminals 81 are soldered to terminal electrodes 75 of housing 70, respectively, and then terminals 81 are embedded in housing 70.

Finally, the opening of container section 71 of housing 70 is rigidly closed with upper lid 78 by a seam-welding method in nitrogen atmosphere.

Angular velocity sensor 200 is thus assembled as discussed above.

1-4. Actions of Angular Velocity Sensor Element and Angular Velocity Sensor

Actions of the angular velocity sensor element and the angular velocity sensor in accordance with the embodiment are demonstrated hereinafter.

A power source voltage is input to power supply electrode 76 of housing 70, then IC 90 having received the voltage of the power source from power supply electrode 76 outputs a drive signal (AC voltage) from drive circuit 91. This drive signal is applied to first drive electrode pad 29a and second drive electrode pad 29b via terminal electrodes 75 and terminals 81. In the case where the AC voltage is applied in the same direction as a direction of polarizations of first drive electrode 32 and second drive electrode 35, tensile stress occurs in both first drive electrode 32 and second drive electrode 35. In the case where the electric current flows in a direction opposite to the direction of the polarizations of electrodes 32 and 35, compressive stress occurs in both first and second drive electrodes 32 and 35.

In this embodiment, an AC voltage is applied to first drive electrode pad 29a in opposite phase to that applied to second drive electrode pad 29b. Those voltage applications allow the compressive stress to occur in one of first drive electrode 32 and second drive electrode 35, and allow tensile stress to occur in a remaining one of electrode 32 and electrode 35. Then, in response to the phases of the AC voltages, first drive vibrator 31 and second drive vibrator 34 are driven to perform a flexural (bending) vibration at velocity V in opposite directions to each other along Z axis.

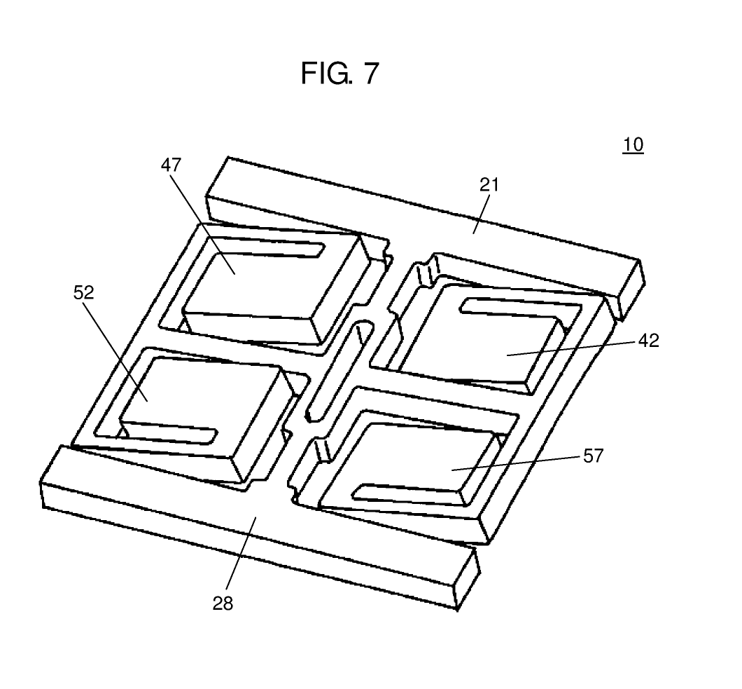

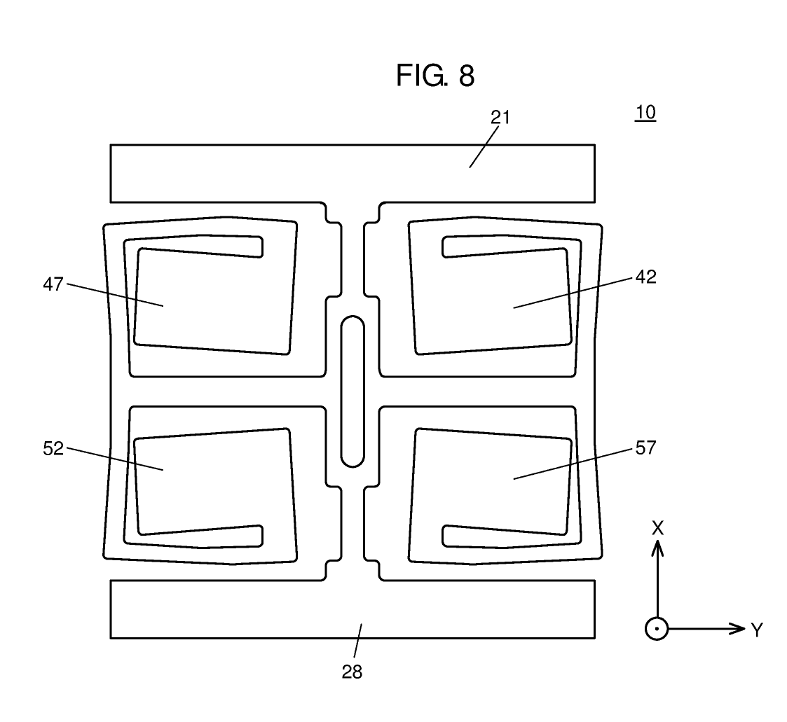

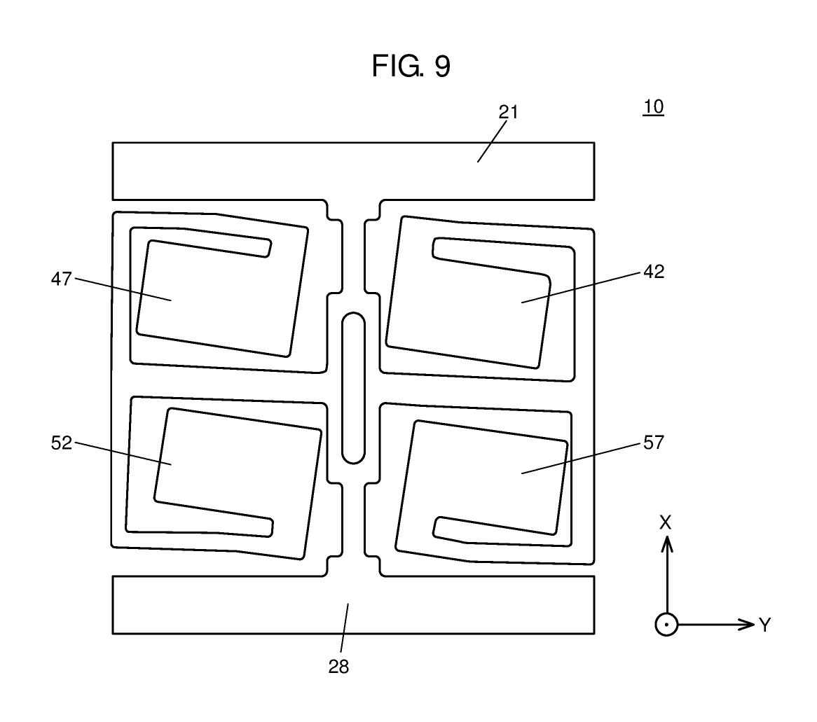

The flexural drive vibration of first drive vibrator 31 transmits to first weight 42 via first detection vibrator 38 and second detection vibrator 40, and also transmits to third weight 57 via fifth detection vibrator 53 and sixth detection vibrator 55. The flexural drive vibration of second drive vibrator 34 transmits to second weight 47 via third detection vibrator 43 and fourth detection vibrator 45, and also transmits to fourth weight 52 via seventh detection vibrator 48 and eighth detection vibrator 50. Then first to fourth weights 42, 47, 57, and 52 are driven to vibrate at velocity V along Z-axis as FIG. 7 shows.

Hereinafter, a case where an angular velocity occurs around X-axis of angular velocity sensor element 10 is studied first.

In this case, first to fourth weights 42, 47, 57, and 52 vibrate in Y-axis direction by Coriolis force, then in some situation, the compressive stress acts on each of first detection electrode 39a, third detection electrode 44a, fifth detection electrode 54a, and seventh detection electrode 49a, each of which is disposed outside, while the tensile stress acts on each of first detection electrode 39b, third detection electrode 44b, fifth detection electrode 54b, and seventh detection electrode 49b, each of which is disposed inside. Angular velocity sensor element 10 then warps such that its right and left portions protrude inside as FIG. 8 shows. In the next situation, the tensile stress acts on each of first detection electrode 39a, third detection electrode 44a, fifth detection electrode 54a, and seventh detection electrode 49a, while the compressive stress acts on each of first detection electrode 39b, third detection electrode 44b, fifth detection electrode 54b, and seventh detection electrode 49b. Angular velocity sensor element 10 then warps such that its right and left portions protrude outside. The tensile stress and compressive stress discussed above allow first detection vibrator 38, third detection vibrator 43, fifth detection vibrator 53, and seventh detection vibrator 48 to vibrate in Y-axis direction, and these vibrations generate electric charges, which are additionally input to first detection electrode pad 22a and third detection electrode pad 22b. The electric charges generated in pad 22a and 22b are output to terminal electrodes 75 as output signals, which then are processed by process circuit 92 and are output from the output electrode provided to housing 70. A detection of these output signals allows detecting the angular velocity around the X-axis.

Next, the case where an angular velocity occurs around Y-axis of angular velocity sensor element 10 is studied hereinafter.

In this case, first to fourth weights 42, 47, 57, and 52 vibrate in X-axis direction by Coriolis force, then in some situation, the compressive stress acts on each of second detection electrode 41a, fourth detection electrode 46b, sixth detection electrode 56b, and eighth detection electrode 51a, while the tensile stress acts on each of second detection electrode 41b, fourth detection electrode 46a, sixth detection electrode 56a, and eighth detection electrode 51b. Then fourth detection vibrator 45 and eighth detection vibrator 50 vibrate in the upward direction on the paper of FIG. 9, while second detection vibrator 40 and sixth detection vibrator 55 vibrate downward as FIG. 9 shows. In the next situation, the tensile stress acts on each of second detection electrode 41a, fourth detection electrode 46b, sixth detection electrode 56b, and eighth detection electrode 51a, while the compressive stress acts on each of second detection electrode 41b, fourth detection electrode 46a, sixth detection electrode 56a, and eighth detection electrode 51b. Then fourth detection vibrator 45 and eighth detection vibrator 50 vibrate downward, while second detection vibrator 40 and sixth detection vibrator 55 vibrate upward. The vibrations of second detection vibrator 40, fourth detection vibrator 45, sixth detection vibrator 55, and eighth detection vibrator 50 in X-axis direction allow generating electric charges, which are additionally input to second detection electrode pad 23a and fourth detection electrode pad 23b. The electric charges generated in pad 23a and 23b are output to terminal electrodes 75 as output signals, which then are processed by process circuit 92 and are output from the output electrode provided to housing 70. A detection of these output signals allows detecting the angular velocity around the Y-axis.

1-5. Advantages

Advantages (Effects) of angular velocity sensor element 10 and angular velocity sensor 200 in accordance with the embodiment are demonstrated hereinafter, and modifications thereof are also described hereinafter.

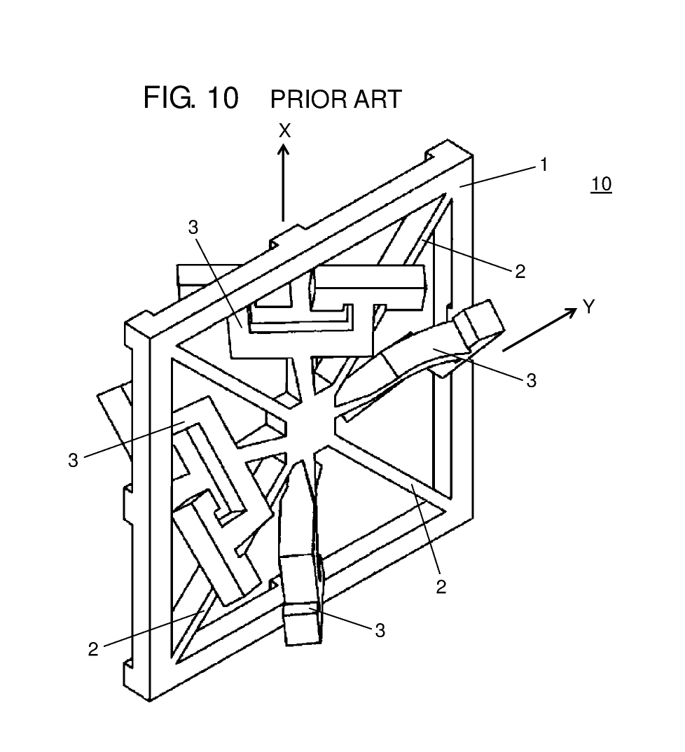

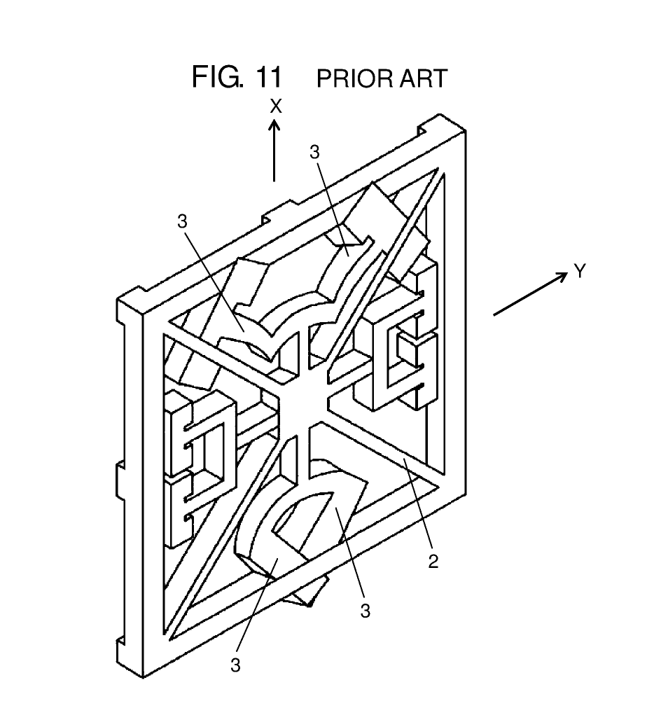

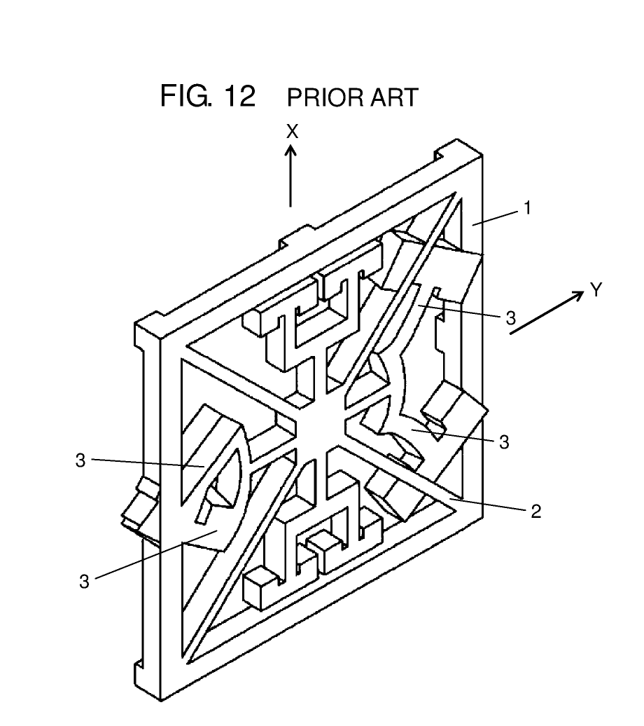

In angular velocity sensor element 10, first drive vibrator 31 is driven to perform a flexural vibration in Z-axis direction, namely, in the thickness direction of sensor element 10. In this case, first drive vibrator 31 vibrates steadier than a case where first drive vibrator 31 is driven to perform a torsional vibration. To be more specific, since a cross section of extending section 25 forms a square, if extending section 25 is to perform a torsional vibration like the conventional example shown in FIG. 10, the vibration is hard to be stable comparing with the case where a cylindrical object is to perform a torsional vibration. In this embodiment, however; extending section 25 can vibrate only in the thickness direction, so that a stable vibration can be expected. Comparing with the case where first drive vibrator 31 is to perform a torsional vibration, the vibration in the thickness direction allows adjusting a speed of vibration with ease. As a result, the drive can be adjusted with ease.

Second drive vibrator 34 is also driven to perform a flexural vibration in Z-axis direction as first drive vibrator 31 is done. A steadier vibration can be thus expected than a case where second drive vibrator 34 is to perform a torsional vibration, so that the vibration speed can be adjusted with ease and the drive can be adjusted with ease.

In this embodiment, extending section 25 is provided with narrow sections 26, and this structure reduces polar moment of inertia of the cross section of extending section 25, so that extending section 25 tends to twist, and each displacement of first drive vibrator 31 and second drive vibrator 34 can be increased. As a result, the detection sensitivity of angular velocity sensor 200 can be improved. In the case of sufficient detection sensitivity available, narrow section 26 may not be provided. The number of narrow sections 26 is not limited two, but the number can be one or more than two, and the location of narrow section 26 is not limited to a center section, but the location can be appropriately selected for twisting narrow section 26 easily.

Extending section 25 in accordance with this embodiment forms a double-supported beam, namely, both ends thereof are respectively fixed to first fixed section 21 and second fixed section 28, so that extending section 25 performs a flexural vibration steadily. In the case of a greater displacement due to a presence of narrow section 26, extending section 25 can also perform a flexural vibration steadily. As a result, a greater voltage can be applied to first drive vibrator 31 and second drive vibrator 34, so that further greater displacements of first and second drive vibrators 31 and 34 can be expected. The detection sensitivity to output signals thus can be improved. In the case of second fixed section 28 being not available, extending section 25 becomes a cantilever beam, however; angular velocity sensor element 10 can still work.

Furthermore, extending section 25 is provided with hole 27, so that extending section 25 forms a structure divided into multiple beams. The polar moment of inertia of each cross section of these beams can be smaller, and extending section 25 thus becomes easy to twist. Although the cross section of each beam becomes smaller, the presence of multiple beams increases the mechanical strength of extending section 25 as a whole. As a result, the displacements of first drive vibrator 31 and second drive vibrator 34 can be increased, thereby improving the detection sensitivity of angular velocity sensor 200. In the case of sufficient detection sensitivity available, hole 27 may not be provided.

In this embodiment, third detection vibrator 43 is disposed symmetrically to first detection vibrator 38 with respect to extending section 25, and fourth detection vibrator 45 is disposed symmetrically to second detection vibrator 40 with respect to extending section 25. This structure allows the vibration traveling from first detection vibrator 38 to first fixed section 21 and second fixed section 28 via first drive vibrator 31 and extending section 25 to be directed opposite to the vibration traveling from third detection vibrator 43 to first fixed section 21 and second fixed section 28 via second drive vibrator 34 and extending section 25, so that these vibrations cancel each other. In a similar manner, the vibration traveling from second detection vibrator 40 to first fixed section 21 and second fixed section 28 via first drive vibrator 31 and extending section 25 is directed opposite to the vibration traveling from fourth detection vibrator 45, so that these vibrations cancel each other. The mechanism discussed above allows suppressing the resonance of placement member 80 where first fixed section 21 and second fixed section 28 are mounted. As a result, an accuracy of the output signal from angular velocity sensor element 10 can be improved. In the case of third and fourth detection vibrators 43 and 45 being not available, angular velocity sensor element 10 can still work.

In this embodiment, seventh detection vibrator 48 is also disposed symmetrically to fifth detection vibrator 53 with respect to extending section 25, and eighth detection vibrator 50 is also disposed symmetrically to sixth detection vibrator 55 with respect to extending section 25. This structure allows the vibration traveling from fifth detection vibrator 53 to first fixed section 21 and second fixed section 28 to be directed opposite to the vibration traveling from seventh detection vibrator 48 to first fixed section 21 and second fixed section 28, so that these vibrations cancel each other. In a similar manner, the vibration traveling from sixth detection vibrator 55 to first fixed section 21 and second fixed section 28 is directed opposite to the vibration traveling from eighth detection vibrator 50, so that these vibrations cancel each other. The mechanism discussed above allows suppressing the resonance of placement member 80 where first fixed section 21 and second fixed section 28 are mounted. As a result, an accuracy of the output signal from angular velocity sensor element 10 can be improved.

In this embodiment, fifth detection vibrator 53 is disposed symmetrically to first detection vibrator 38 with respect to first drive vibrator 31, and sixth detection vibrator 55 is disposed symmetrically to second detection vibrator 40 with respect to first drive vibrator 31. This structure allows achieving uniform weight balance with respect to first drive vibrator 31, so that first drive vibrator 31 can be driven to vibrate in a stable manner. In a case where fifth detection vibrator 53 and sixth detection vibrator 55 are not available, angular velocity sensor element 10 can still work.

Moreover, seventh detection vibrator 48 is disposed symmetrically to third detection vibrator 43 with respect to second drive vibrator 34, and eighth detection vibrator 50 is disposed symmetrically to fourth detection vibrator 45 with respect to second drive vibrator 34. This structure allows achieving uniform weight balance with respect to second drive vibrator 34, so that second drive vibrator 34 can be driven to vibrate in a stable manner. In the case where seventh detection vibrator 48 and eighth detection vibrator 50 are not available, angular velocity sensor element 10 can still work.

In this embodiment, the presence of first to fourth weights 42, 47, 57, and 52 allows generating Coriolis force efficiently. These weights are not necessary, and in the case in which great Coriolis force is not required, these weights can be omitted.

In this embodiment, first weight 42 is placed in the space of which three sides out of four sides are surrounded by first drive vibrator 31, first detection vibrator 38, and second detection vibrator 40. This structure allows effective utilization of space, thereby downsizing angular velocity sensor element 10. Each of second to fourth weights 47, 57, and 52 is placed in a similar manner to first weight 42, so that effective utilization of space can be achieved, thereby downsizing angular velocity sensor element 10.

Each of first to fourth weights 42, 47, 57, and 52 is shaped like a rectangle, which fits to a vacant space, thereby achieving effective utilization of space. However, the shape of these weights is not limited to a rectangle.

A connection of first weight 42 to an end of second detection vibrator 40 allows generating Coriolis force efficiently. However, in the case where great Coriolis force not needed, first weight 42 is not necessary to be placed there. For instance, it can be connected to a center portion of second detection vibrator 40 or to first detection vibrator 38. The placements of second to fourth weights 47, 57, and 52 at the locations shown in this embodiment also allow efficient generation of Coriolis force; however, the placements are not limited to these locations.

Angular velocity sensor element 10 in accordance with the embodiment is to detect angular velocities around X-axis and Y-axis; however, it can be combined with a structure that detects an angular velocity around Z-axis, thereby detecting angular velocities around the three axes.

Angular velocity sensor element 10 in accordance with the embodiment uses inverse piezoelectric effect for driving first and second drive vibrators 31 and 34; however, the driving method is not limited to the piezoelectric method. For instance, electrostatic force can be used. In this case, each of first drive electrode 32 and second drive electrode 35 is provided with a counter electrode, and use of the electrostatic force between first drive electrode and its counter electrode as well as the electrostatic force between second drive electrode 35 and its counter electrode allows first drive vibrator 31 and second drive vibrator 34 to be driven to vibrate.

Angular velocity sensor element 10 in accordance with the embodiment uses piezoelectric effect for detecting vibrations; however, another detection method can be used.

In this embodiment, X-axis, Y-axis, and Z-axis are used for reasons of convenience, so that the names of the axes can be interchangeable with each other as long as the axes are perpendicular to each other. The names of X-axis, Y-axis, and Z-axis are justly named, so that they are replaceable with any one of a first axis, second axis, and third axis respectively.

In the embodiment, the term of ‘perpendicular’ includes substantially perpendicular relation, and the term of ‘parallel’ includes substantially parallel relation.

In the embodiment, the terms of top face, underside, lateral face refer to names viewed from relative directions and the terms are used for reasons of convenience, so that these names can be changed depending on the location or attitude of the angular velocity sensor element or the angular velocity sensor.

Driving of the angular velocity sensor element according to the present disclosure can be adjusted with ease, and is useful to be used in angular velocity sensors employed in a variety of electronic apparatuses.

What is claimed is:

1. An angular velocity sensor element comprising:
a base section;
an extending section including an end coupled to the base section, and extending in a direction of a first axis;
a first beam coupled to the extending section, extending in a direction of a second axis crossing the first axis, and provided with a first electrode;
a first arm section coupled to the first beam, extending in the direction of the first axis, and provided with a second electrode; and
a second arm section coupled to the first arm section, extending in the direction of the second axis, and provided with a third electrode.

2. The angular velocity sensor element according to claim 1, wherein:
the extending section includes a narrow section having a width smaller than remaining part of the extending section in the direction of the second axis.

3. The angular velocity sensor element according to claim 1, wherein:
the extending section is provided with a hole passing through the extending section in the direction of a third axis perpendicular to the first and second axes.

4. The angular velocity sensor element according to claim 1, further comprising:
a second beam disposed in symmetric relation to the first beam with respect to the extending section;
a third arm section coupled to the second arm section and disposed in symmetric relation to the first arm section with respect to the extending section; and
a fourth arm section coupled to the third arm section and disposed in symmetric relation to the second arm section with respect to the extending section.

5. The angular velocity sensor element according to claim 4, further comprising:
a fifth arm section disposed in symmetric relation to the third arm section with respect to the second beam; and
a sixth arm section disposed in symmetric relation to the fourth arm section with respect to the second beam.

6. The angular velocity sensor element according to claim 1, further comprising:
a fifth arm section disposed in symmetric relation to the first arm section with respect to the first beam; and
a sixth arm section disposed in symmetric relation to the second arm section with respect to the first beam.

7. The angular velocity sensor element according to claim 1, wherein:
the first beam is driven to perform a flexural vibration in a direction of a third axis perpendicular to the first and second axes,
the first arm section detects an angular velocity around the first axis, and
the second arm section detects an angular velocity around the second axis.

8. The angular velocity sensor element according to claim 1, further comprising:
a weight coupled to the second arm section.

9. An angular velocity sensor comprising:
an angular velocity sensor element including:
a base section;
an extending section including an end coupled to the base section, and extending in a direction of a first axis;
a first beam coupled to the extending section, extending in a direction of a second axis crossing the first axis, and provided with a first electrode;
a first arm section coupled to the first beam, extending in the direction of the first axis, and provided with a second electrode; and
a second arm section coupled to the first arm section, extending in the direction of the second axis, and provided with a third electrode;
a drive circuit which outputs a drive signal that drives the angular velocity sensor element; and
a process circuit which processes an output signal from the second electrode and the third electrode of the angular velocity sensor element.

10. The angular velocity sensor according to claim 9, wherein:
the drive circuit and the process circuit are integrated as an integrated circuit.

11. The angular velocity sensor according to claim 9, further comprising:
a housing accommodating the angular velocity sensor element, the drive circuit, and the process circuit; and
electrodes formed on an outer surface of the housing and coupled electrically to the drive circuit and the process circuit, respectively.

12. The angular velocity sensor according to claim 9, wherein:
the first drive vibrator is driven to perform a flexural vibration in a direction of a third axis perpendicular to the first and second axes,
the first detection vibrator detects an angular velocity around the first axis, and
the second detection vibrator detects an angular velocity around the second axis.

13. The angular velocity sensor element according to claim 9, wherein:
the extending section includes a narrow section having a width smaller than remaining part of the extending section in the direction of the second axis.

14. The angular velocity sensor element according to claim 9, wherein:
the extending section is provided with a hole passing through the extension section in the direction of a third axis perpendicular to the first and second axes.

15. The angular velocity sensor according to claim 9, wherein the angular velocity sensor element further includes:
a second beam disposed in symmetric relation to the first beam with respect to the extending section;
a third arm section coupled to the second arm section and disposed in symmetric relation to the first arm section with respect to the extending section; and
a fourth arm section coupled to the third arm section and disposed in symmetric relation to the second arm section with respect to the extending section.

16. The angular velocity sensor according to claim 15, wherein the angular velocity sensor element further includes:
a fifth arm section disposed in symmetric relation to the third arm section with respect to the second beam; and
a sixth arm section disposed in symmetric relation to the fourth arm section with respect to the second beam.

17. The angular velocity sensor according to claim 9, wherein the angular velocity sensor element further includes:
a fifth arm section disposed in symmetric relation to the first arm section with respect to the first beam; and
a sixth arm section disposed in symmetric relation to the second arm section with respect to the first beam.

18. The angular velocity sensor according to claim 9, wherein the angular velocity sensor element further includes a weight coupled to the second arm section.

19. An angular velocity sensor element comprising:
a base section;
an extending section including an end coupled to the base section, and extending in a direction of a first axis;
a first drive vibrator coupled to the extending section, and extending in a direction of a second axis perpendicular to the first axis;
a first vibration detector coupled to the first drive vibrator, and extending in the direction of the first axis; and
a second vibration detector coupled to the first vibration detector, and extending in the direction of the second axis, wherein:
the first drive vibrator is driven to perform a flexural vibration in a direction of a third axis perpendicular to the first and second axes,
the first vibration detector detects an angular velocity around the first axis, and
the second vibration detector detects an angular velocity around the second axis.
